(19) United States
(12) Patent Application Publication
(10) Pub. No.: US 2020/0047995 A1
(43) Pub. Date: Feb. 13, 2020

(54) Garbage can

(71) Applicant: HUIZHEN CHEN, Yongkang (CN)

(72) Inventor: HUIZHEN CHEN, Yongkang (CN)

(21) Appl. No.: 16/655,470

(22) Filed: Oct. 17, 2019

Related U.S. Application Data
(63) Continuation-in-part of application No. 15/251,024, filed on Aug. 30, 2016, now Pat. No. 10,450,133.

(30) Foreign Application Priority Data
May 17, 2016 (CN) 20160351760.6
May 17, 2016 (CN) 201620468892.2

(51) Int. Cl. B65F 1/06; B65F 1/16

(52) U.S. Cl. CPC B65F 1/062; B65F 2210/126; B65F 2210/129; B65F 1/1623

(57) ABSTRACT

A trash can includes a can body, a trash bag being in use and arranged in the can body, a trash inlet formed in the upper part of the can body, an upper cover for sealing or opening the trash inlet, a support frame being arranged in the can body and including a through hole, and spare trash bags being continuously stacked and then sleeving the outer side of the support frame.

### CROSS-REFERENCE TO RELATED APPLICATIONS

This application is a continuation-in-part of application Ser. No. 15/251,024, filed on Aug. 30, 2016, which claims priority to and the benefits of priority to Chinese Application No. CN 201620468892.2, filed May 17, 2016, and Chinese Application No. CN 201610351760.6, filed on May 17, 2016, which are all hereby incorporated by reference in their entirety.

### FIELD

This present invention relates to a trash can.

### BACKGROUND

At present, there are various trash can structures in the art. For example, Chinese patent No. CN201120017941.8 discloses a “convenient trash can” which comprises a horizontal partition plate proximate to the bottom part of the trash can, a long slot formed in the middle of the partition plate at a lower part of the convenient trash can, a plastic trash bag roll placed below the long slot. The outmost trash bag of the trash bag roll passes through the middle part of the long slot in the middle of the partition plate and opens at an upper opening. The edge of the upper opening is turned back outwards and sleeves the edge of the upper opening of a can body. A collar clamped on the edge of the upper opening is arranged in the upper opening of the can body, and the collar is arranged outside the trash bag which sleeves the edge of the upper opening of the can body. The whole roll of trash bags are put into the trash can in advance and are used one by one, so that the trash can is simple in structure and convenient to be used. However, the trash can has the following shortcomings: because the trash bags of the trash cans are arranged at the bottom part of the can body, when one trash bag is damaged, trashes and sewage easily pollute a spare trash bag to cause waste of the trash bags. Meanwhile, the sleeving operation of the trash bag as discussed above is also very inconvenient.

### SUMMARY

One objective of the present invention is to provide a trash can which facilitates reliably storing spare trash bags in the trash can, preventing trashes and sewage from polluting the spare trash bags, and conveniently replacing the trash bag in use.

The trash can in accordance with an embodiment of the present application comprises a trash bag arranged in a can body of the trash can, a trash inlet formed in the upper part of the can body, an upper cover for sealing or opening the trash inlet, and a support frame arranged in the can body of the trash can. The trash bag is an elongated tubular trash bag. Spare trash bags are continuously stacked and then sleeve the outer side of the support frame. A trash bag in use passes through a through hole in the support frame and is arranged at the inner side of the support frame. The support frame keeps an opening part of the trash bag open. The bottom part of the trash bag is sealed in a knotting manner. When the trash bag is pulled, the elongated tubular trash bag is pulled out from the through hole in the support frame. The can body of the trash can comprises an upper-section can body and a lower-section can body. The support frame is located in the upper-section can body. The lower-section can body is provided with a door, which can be opened in a rotating manner, and a cutter for cutting the trash bag at the inner side of the door body.

The trash can in accordance with the present invention has the following advantages: 1) the spare trash bags are continuously stacked and then sleeve the outer side of the support frame so that the trash bags can be stored into the trash can; 2) the trash bag in use is located at the inner side of the support frame and can prevent the trashes from polluting the support frame; 3) because the support frame is located in the upper-section can body, the trash bag in use passes through the through hole in the support frame and is arranged at the inner side of the support frame, the spare trash bags are continuously stacked and then sleeve the outer side of the support frame, the spare trash bags are not polluted in case the trash bag of the trash can in use is damaged; 4) the support frame keeps the opening part of the trash bag open, the bottom part of the trash bag is sealed in a knotting manner, and the elongated tubular trash bag is pulled out from the through hole in the support frame when the trash bag is pulled, so that the operation of replacing the trash bag is very convenient; 5) the lower-section can body is provided with a door body which can be opened in a rotating manner, and the cutter for cutting the trash bag is arranged at the inner side of the door body, so that the trash bag is full of the trashes and the door body is opened, the elongated tubular trash bag is cut off by the cutter, and the trashes can be conveniently taken out; 6) the operation of replacing the trash bag is quickly completed after a trash bag is pulled out and its bottom part is knotted.

According to an embodiment of the present application, a pedal is arranged in the trash can for driving the upper cover to open or close through a connecting rod. Thorough this structure, the upper cover can be conveniently opened through the pedal. In the alternative, the trash can may also adopt a pedal-free structure.

According to another embodiment of the present application, an outward folded edge is arranged at the lower part of the support frame for facilitating sleeving and locating of the spare trash bags and preventing the trash bag and the spare trash bags from sliding off.

As an embodiment, an elastic cushion ring which is matched with the lower part of the support frame is arranged in the trash can. The elastic cushion ring has a buffer effect when the trash bag is pulled, and prevents the trash bag from being damaged when the trash bag is pulled.

According to yet another embodiment, the opening part of the upper-section can body is provided with a locating snap ring which comprises a locating and clamping block, and a locating hole matched with the locating and clamping block is formed in the upper-section can body.

According to a further embodiment of the present application, an inner cover is arranged in the locating snap ring, an inner cover spring compels the inner cover to seal the trash inlet, and the inner cover can further seal the trash bag and prevent an odor from leaking. In the alternative, the trash can may also adopt an inner cover-free structure.

A locking knob for locking the inner cover may be arranged in the locating snap ring, and the inner cover may be locked or arranged at a depressible position by rotating the locking knob. The trash can may also adopt a locking knob-free structure.

The trash can may be provided with a base, and the lower-section can body may be fixed on the base so that the structure is beneficial to manufacturing of the trash can.

The upper and lower rotating shafts of the door body may respectively be located on the lower part of the upper-section can body and the base. A locking mechanism matched with the side wall of the door body may be arranged on the side surface of the lower-section can body, and the door body may be conveniently opened or closed by operating the locking mechanism.

The locking mechanism comprises clamping holes and clamping hooks. The clamping holes are formed in the side wall of the door body. The clamping hooks are arranged on the side surface of the lower-section can body. A pressing slope is arranged at the front end of each clamping hook. When the pressing slope at the front end of each clamping hook is in contact with the corresponding clamping hole, the clamping hook moves and enters the corresponding clamping hole. Each clamping hook is provided with a key which is exposed outside the outer surface of the lower-section can body, and each clamping hook can move and exit from the corresponding clamping hole by pressing the corresponding key to open the door body.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

Other aspects of the disclosed garbage can will become apparent from the following detailed description, the accompanying drawings and the appended claims.

### BRIEF DESCRIPTION OF THE DRAWINGS

In the drawings:

FIG. 1 is a perspective view of the trash can in accordance with an embodiment of the present application.

FIG. 2 is a diagrammatic drawing when the door body of the trash can is opened.

FIG. 3 is a diagrammatic drawing when the cutter cuts the trash bag when the door body of the trash can is opened.

FIG. 4 is the cross-section illustrative view (the trash bag and the connecting rod are not shown in the view) of the trash can in accordance with an embodiment of the present application.

FIG. 5 is a perspective view of the trash can when the support frame is separated from the trash bag.

FIG. 6 is the cross-section illustrative view when the support frame and the trash bag are installed.

FIG. 7 is the exploded view (the trash bag is not shown in the view) of the components of the trash can.

FIG. 8 is an exploded view (the trash bag, cutter and some other elements are not shown in the view) of the components of the trash can according to another embodiment of the present application.

FIG. 9 is an exploded view of components of a lower portion of the trash can of FIG. 8.

FIG. 10 is an exploded view of components of an upper portion of the trash can of FIG. 8.

FIG. 11 is top perspective view of the trash can with the upper cover open and the inner cover closed.

FIG. 12 is a top perspective view of the trash can with the upper cover open and the inner cover open.

FIG. 13 is a bottom perspective view of the inner cover and related components of the embodiment of FIG. 8.

FIG. 14 is an exploded view (the trash bag and other elements are not shown in the view) of the components of the trash can according to another embodiment of the present application.

FIG. 15 is a top perspective view the upper cover in operative connection with the inner cover and related elements according the embodiment of FIG. 14.

FIG. 16 is a view similar to FIG. 15 except that the upper cover and inner cover are in the closed position.

FIG. 17 is a front view of the tang of the upper cover being engaged by two opposing hook arms of the push-push mechanism when the upper cover is in the closed position.

FIG. 18 is a top perspective view of another version of the support frame and also a portion of the elastic cushion ring.

FIG. 19 is a bottom perspective view of the elastic cushion ring with springs mounted thereon.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

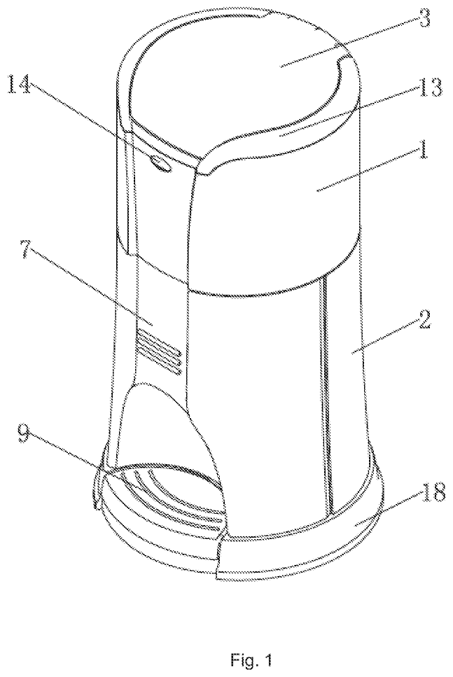

Throughout the present description for the embodiments, the terms “upper”, “lower”, “top”, “bottom”, “left”, “right”, “front”, “forward”, “rear”, and “rearward” shall define directions or orientations with respect to the trash can as illustrated in FIG. 1. It will be understood that the spatially relative terms “upper”, “lower”, “top”, “bottom”, “left”, “right”, “front”, “forward”, “rear”, and “rearward” are intended to encompass different orientations of the trash can in use or operation in addition to the orientation depicted in the figures. For example, if the holder in the figures is turned over, elements described as “upper” elements or features would then be “lower” elements or features.

Throughout the present description, the terms “longitudinal” and “lateral” shall define directions with respect to the trash can. Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

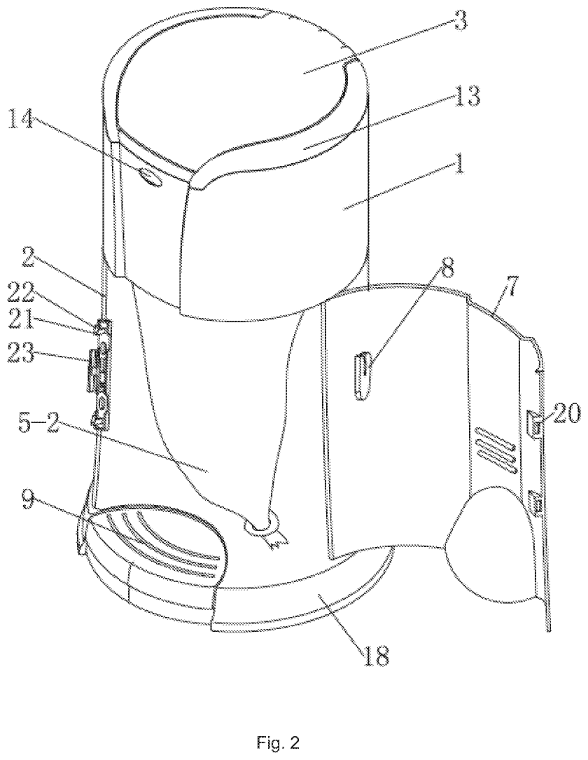

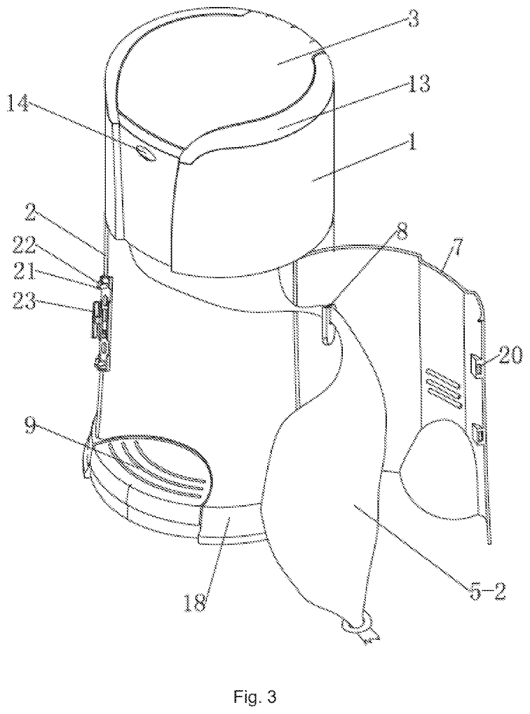

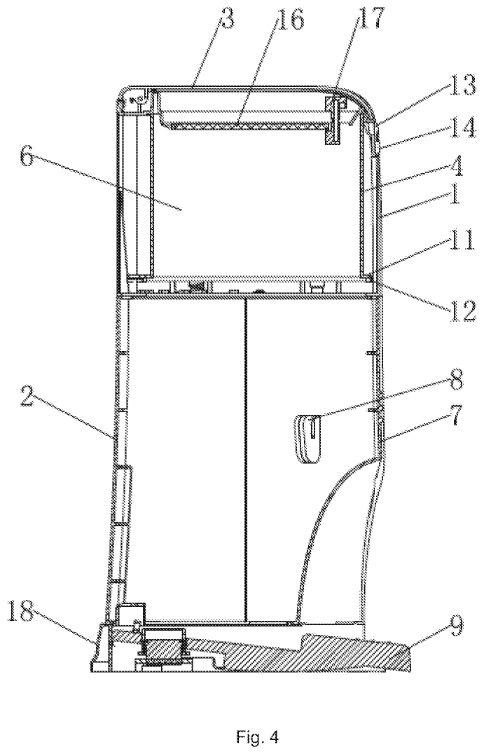

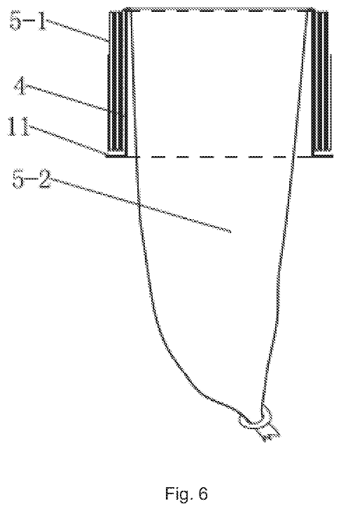

As shown in FIGS. 1 to 7, according to an embodiment of the present application, the trash can comprises a trash bag arranged in a can body which comprises an upper-section can body 1 and a lower-section can body 2, a trash inlet formed in the upper part of the can body, an upper cover 3 can for sealing or opening the trash inlet, and a support frame 4 arranged in the can body. The trash bag 5 is an elongated tubular trash bag, spare trash bags 5-1 are continuously stacked and then sleeve the outer side of the support frame 4. A trash bag 5-2 in use passes through a through hole in the support frame and is arranged at the inner side of the support frame. The support frame keeps an opening part of the trash bag open. The trash bag seals the bottom part of the trash bag in a knotting manner. When the trash bag is pulled, the elongate tubular trash bag 5 is pulled out from the through hole 6 in the support frame 4. The support frame 4 is located in the upper-section can body 1. The lower-section can body 2 is provided with a door body 7 which can be opened in a rotating manner, and a cutter 8 for cutting the trash bag is arranged at the inner side of the door body.

In accordance with an embodiment, a pedal 9 is arranged in the trash can and drives the upper cover 3 to open or close through a connecting rod 10. The upper cover can be conveniently opened through the pedal by the structure.

In accordance with another embodiment, an outward folded edge 11 is arranged at the lower part of the support frame 4, and is beneficial to sleeving of the spare trash bags. An elastic cushion ring 12 which is matched with the lower part of the support frame is arranged in the trash can. The elastic cushion ring has a buffer effect when the trash bag is pulled, and prevents the trash bag from being damaged when the trash bag is pulled. The opening part of the upper-section can body is provided with a locating snap ring 13. A locating and clamping block 14 is arranged in the locating snap ring, and a locating hole 15 matched with the locating and clamping block is formed in the upper-section can body.

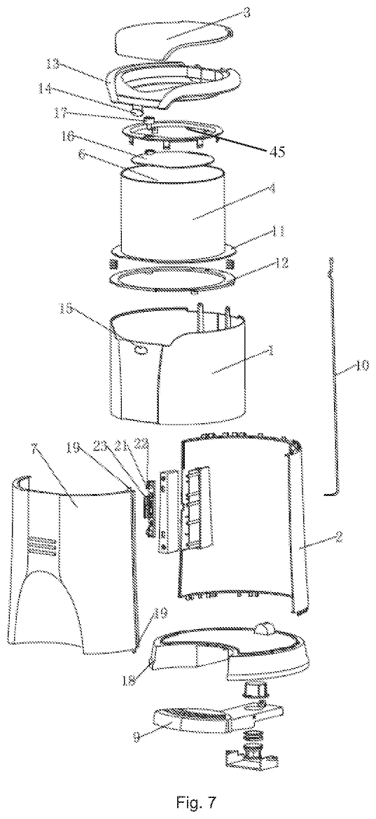

As an embodiment, an inner cover 16 is arranged in the locating snap ring 13, an inner cover spring 45 (FIG. 7) compels the inner cover 16 to seal the trash inlet, and a locking knob 17 for locking the inner cover is arranged in the locating snap ring. The inner cover 16 can be locked or arranged at the depressible position by rotating the locking knob 17, and the inner cover can further seal the trash bag and prevent an odor from leaking.

As an embodiment, the trash can is provided with a base 18, the lower-section can body 2 is fixed on the base, upper and lower rotating shafts 19 of the door body are located on the lower part of the upper-section can body and the base respectively, a locking mechanism matched with the side wall of the door body is arranged on the side surface of the lower-section can body, and the door body can be conveniently opened or closed by operating the locking mechanism.

According to yet another embodiment, the locking mechanism comprises clamping holes 20 and clamping hooks 21, wherein the clamping holes 20 are formed in the side wall of the door body 7; the clamping hooks 21 are arranged on the side surface of the lower-section can body; a pressing slope 22 is arranged at the front end of each clamping hook; when the pressing slope at the front end of each clamping hook is in contact with the corresponding clamping hole, the clamping hook moves and enters the corresponding clamping hole; each clamping hook is provided with a key 23 which is exposed outside the outer surface of the lower-section can body; and each clamping hook can move and exit from the corresponding clamping hole by pressing the corresponding key to open the door body.

The spare trash bags are continuously stacked and then sleeve the outer side of the support frame so that the trash bag can be stored into the trash can; and the trash bag in use is located at the inner side of the support frame and can prevent the trashes from polluting the support frame. The support frame is located in the upper-section can body, and the spare trash bag is continuously stacked and then sleeves the outer side of the support frame, so that the spare trash bag is not polluted after the trash bag is damaged; the support frame keeps the opening part of the trash bag open, the trash bag seals the bottom part of the trash bag in a knotting manner, and the long tubular trash bag is pulled out from the through hole in the support frame when the trash bag is pulled, so that the operation of replacing the trash bag is very convenient. The lower-section can body is provided with the door body which can be opened in a rotating manner, and the cutter for cutting the trash bag is arranged at the inner side of the door body so that the door body can be opened when the trash bag is full of trashes. The elongate tubular trash bag can be cut off by the cutter, and the trashes can be conveniently taken out. The bottom part of the justly pulled trash bag is knotted. The operation of replacing the trash bag is very simple and convenient.

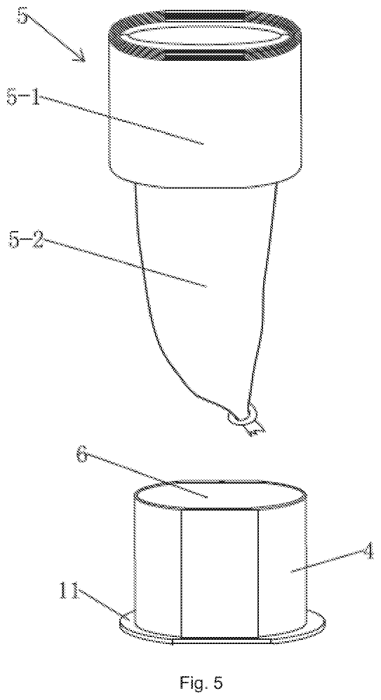

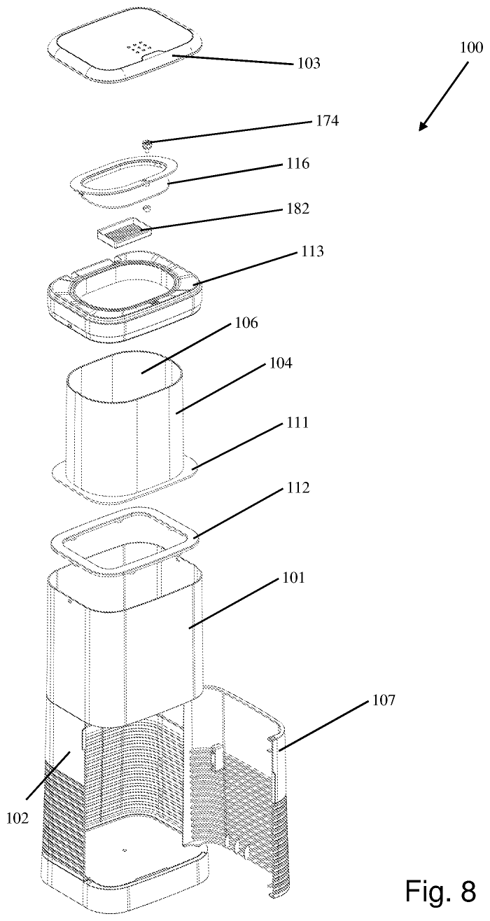

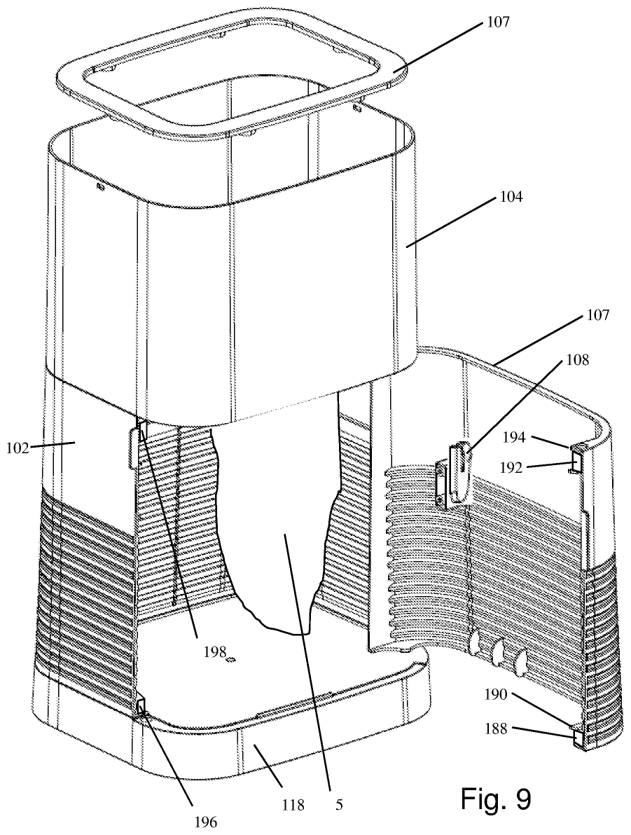

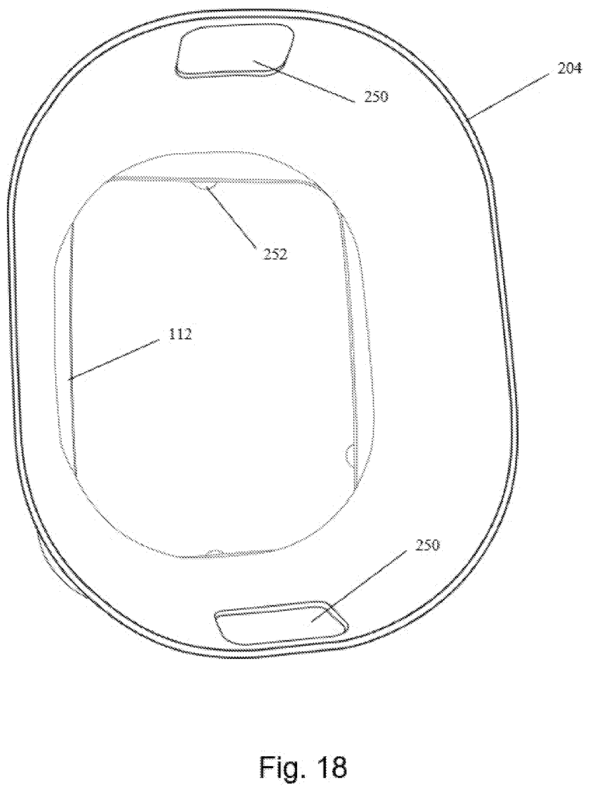

FIGS. 8 to 13 and 17-19 show another embodiment of the present application. In this embodiment elements that are similar in function with the first embodiment of FIGS. 1-7, will be given the same reference numbers. Referring to FIG. 8, the trash can 100 comprises a trash bag 5 (FIG. 9) arranged in a can body which comprises an upper-section can body 101 and a lower-section can body 102, a trash inlet formed in the upper part of the can body, an upper cover 103 can for sealing or opening the trash inlet, and a support frame 104 arranged in the can body. FIG. 18 shows another version of a support frame 204 that includes opposite side openings 250 that hold the trash bag 5. The trash bag 5 (FIG. 9) is an elongated tubular trash bag, spare trash bags 5-1 (FIG. 5) are continuously stacked and then sleeve the outer side of the support frame 104. A trash bag 5-2 (FIG. 5) in use passes through a through hole 106 in the support frame 104 and is arranged at the inner side of the support frame 104. The support frame 104 keeps an opening part of the trash bag open. The trash bag seals the bottom part of the trash bag in a knotting manner. When the trash bag is pulled, the elongate tubular trash bag 5 is pulled out from the through hole 106 in the support frame 104. The support frame 104 is located in the upper-section can body 101. The lower-section can body 102 is provided with a door body 107 which can be opened in a rotating manner, and a cutter 108 for cutting the trash bag is arranged at the inner side of the door body 107.

Similar to the embodiment of FIGS. 1-7, the trash may optionally include a pedal 9 that is arranged in the trash can and drives the upper cover to open or close though a connecting rod 10. The upper cover can be conveniently opened through the pedal by the structure.

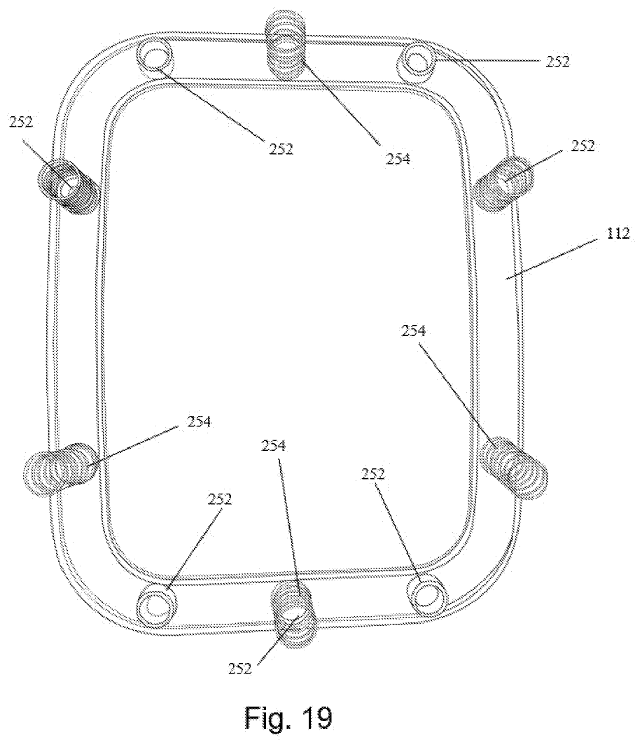

An outward folded edge 111 is arranged at the lower part of the support frame 104, and is beneficial to sleeving of the spare trash bags. An elastic cushion ring 112 which is matched with the lower part of the support frame 104 is arranged in the trash can. The elastic cushion ring has a buffer effect when the trash bag is pulled, and prevents the trash bag from being damaged when the trash bag is pulled. Referring to FIG. 19, the elastic cushion ring 112 includes bosses 252 that extend downwardly. One or more of the bosses 252 are securely received by compression springs 254, which contribute to the buffer effect when the trash bag is pulled. For example, the bosses 252 may be press fitted into their respective springs 254. The opening part of the upper-section can body is provided with a locating snap ring 113. The locating snap ring fits over the upper edge of the upper-section can body 101.

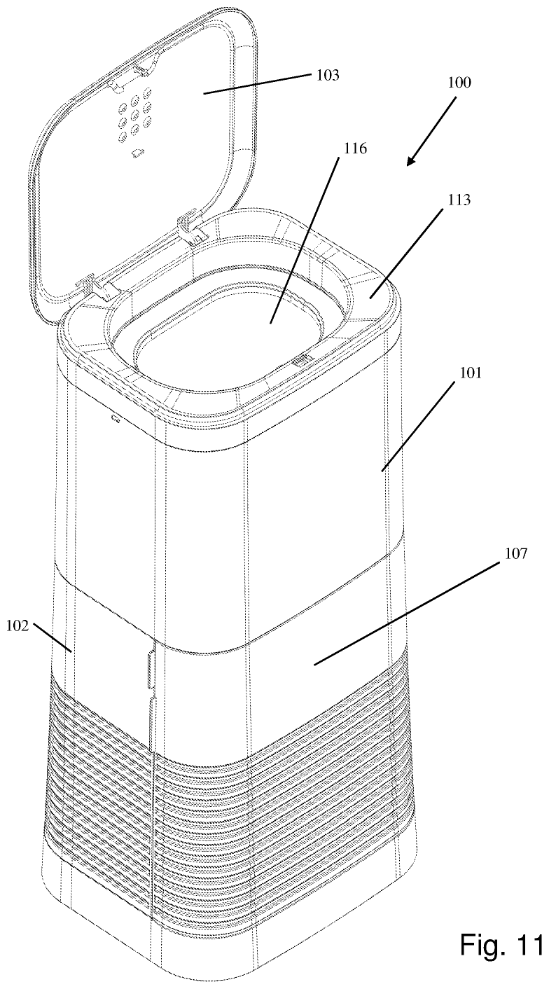

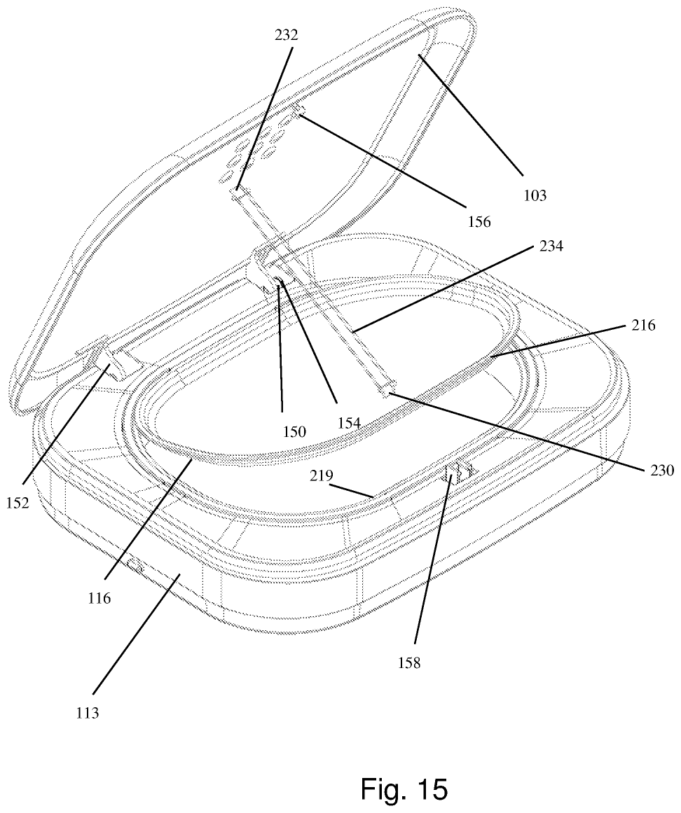

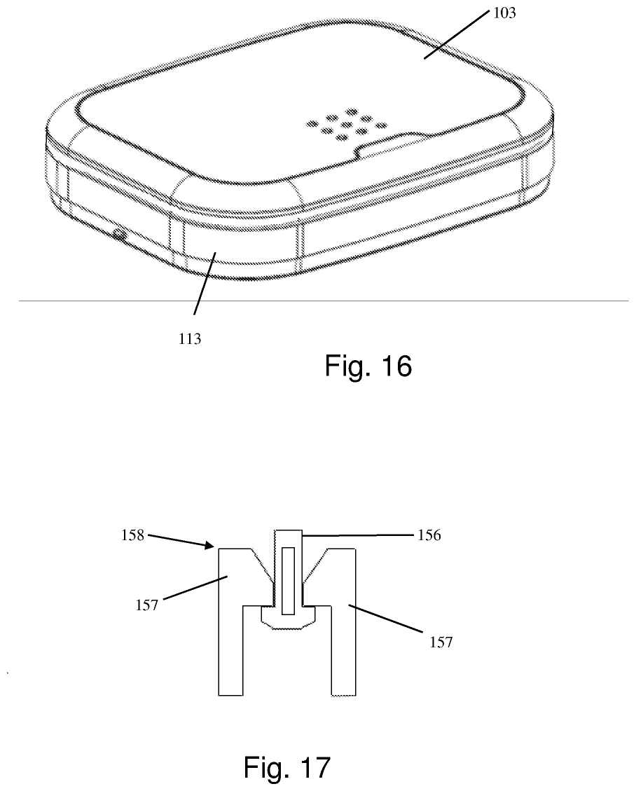

The upper cover 103 may be opened and closed by pushing it with a hand of a user. In particular, the upper cover 103 is pivotally attached to trash can as seen in FIGS. 11, 12, and 15. Specifically, with reference to FIG. 15, a pivot pin 150 is journaled through the rear end of the locating snap ring 113 and through bearing members 152 attached to the underside of the upper cover 103. The pivot pin 150 may also extend through a torsion spring 154 that urges the upper cover 103 upwardly. The upper cover 103 includes a generally T-shaped tang 156 that depends downwardly from the underside of the upper cover 103. A push-push mechanism 158 is provided in an opening of the locating snap ring 113 at the front end and is in operative connection with the upper-section can body 101. The tang 156 is removably received by the push-push mechanism 158. In the closed position of the upper cover 103 as seen in FIGS. 16 and 17, the push-push mechanism 158 engages the tang 156 to secure the upper cover 103 to the locating snap ring 113. Specifically, the tang 156 is inserted between two opposing hook arms 157 of the push-push mechanism 158 that engage the tang in the closed position. When the upper cover 103 is pushed, the push-push mechanism 158 releases the tang 156 by causing the hook arms 157 to move away and disengage from the tang 156 to enable the upper cover 103 to pivot away from the locating snap ring 113. The biasing force of the torsion spring 154 urges the upper cover 103 upward to open it. When the upper cover 103 is then pushed down such that the tang 156 is reinserted into the push-push mechanism 158, the push-push mechanism 158 engages the tang 156 to secure the upper cover 103 to the locating snap ring 113 in the closed position. So, in essence, the upper cover 103 may be opened and closed by the touch and push of the hand of a user.

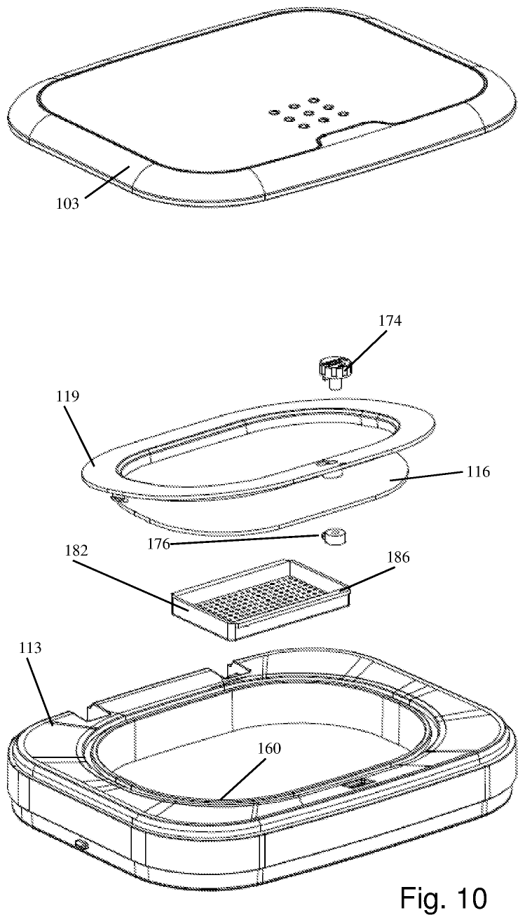

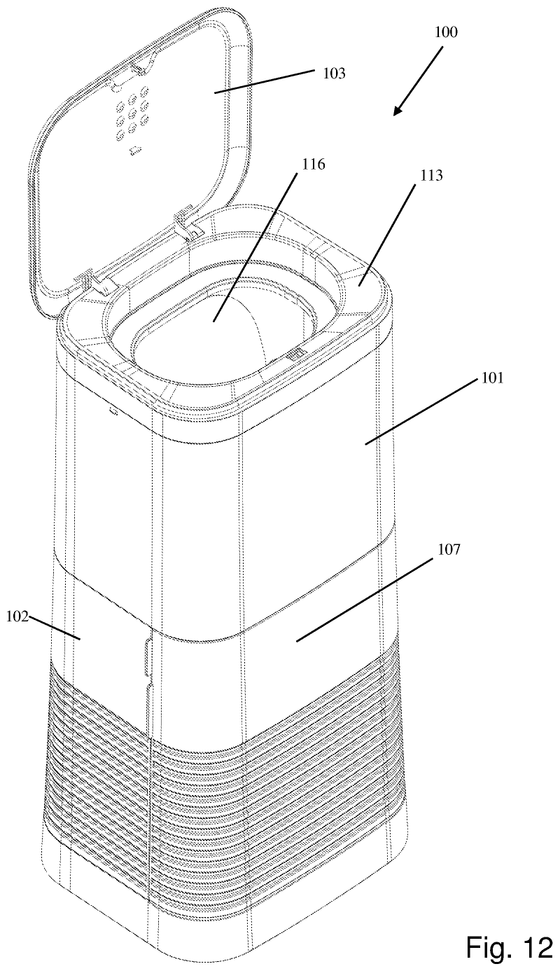

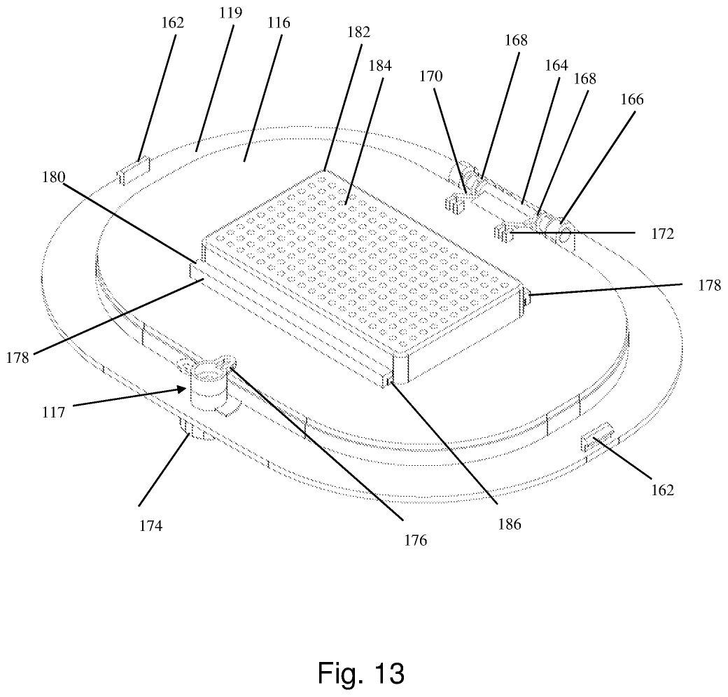

An inner cover 116 is arranged in an outer frame 119 as seen in FIGS. 1, 10, and 13. The outer frame 119 is position upon the inner rim 160 (FIG. 10) of the locating snap ring 113 so that the inner rim 160 supports the outer frame 119. The outer frame 119 includes a pair of hooks 162 that engage the underside of the locating snap ring 113 to removably attach the outer frame 119 to the locating snap ring 113. Referring to FIG. 13, a pivot pin 164 is journaled through bearings 166 attached to the underside of the rear end of the outer frame 119. The pivot pin 164 also extends through a torsion springs 168. The leg 170 of each torsion spring 168 engages the underside of the inner cover 116 and is press fitted between two support plates 172 attached to the inner cover 116 to secure the leg 170 to the inner cover 116. The torsion springs 168 bias or urge the inner cover 116 against the outer frame 119 in the closed position (FIG. 11) to further seal the trash inlet and prevent an odor from leaking. The inner cover 116 may pivot downwardly away from the outer frame by a force (e.g. a user pushing the inner cover with his or her hand) that is sufficient to overcome the biasing force of the torsion springs 168. In this open position (FIG. 12), the trash inlet is opened so that trash items may be placed in the trash bag. Once the downward force is released from the inner cover 116, the biasing force of the torsion springs 168 moves the inner cover 116 against the outer frame 119 in the closed position.

A locking knob 117 for locking the inner cover 116 is arranged in the outer frame 119 to lock the inner cover 116 to the outer frame 119 in the closed position by rotating knob 174 of the locking knob 117. In particular, the locking knob 117 may be in the form of a cam lock and includes a cam or arm 176 and the knob 174. In the locked position, the arm 176 engages the underside of the inner cover 116 to prevent the inner cover 116 from pivoting down. Rotation of the knob 174 ninety degrees rotates and moves the arm 176 away from the inner cover 116 to the position shown in the phantom lines of FIG. 13. In this unlocked position, the inner cover 116 may be pivoted downward to open the trash inlet of the trash can.

A pair of parallel rails 178 are attached to the underside of the inner cover 116. Each rail includes a hook flange 180 that extends inwardly toward the other rail. A freshener housing 182 is provided in the trash can. The freshener housing 182 houses a freshener for masking or reducing the odors in the trash container. The freshener housing 182 includes a bottom wall 184 that has a plurality of opening or perforations to allow the emission of the fresh odor from the freshener in the freshener housing 182. The freshener housing 182 also includes a pair of outer flanges 186 (FIG. 10) that extend outwardly from the top end of the freshener housing 182. The freshener housing 182 may be removably mounted to the underside of the inner cover 116. This is accomplished by having the hook flanges 180 slidably receive the respective outer flanges 186 of the freshener housing 182 with the outer flanges 186 positioned upon the hook flanges 180. The freshener housing 182 may be removed from the inner cover by sliding the freshener housing off of the rails. Once removed, a user can replace the freshener in the housing with a new freshener and then slide the freshener housing back on the rails 178.

As seen in FIG. 9, the trash can is provided with a base 118. The lower-section can body 102 is fixed on the base 118. A door body 107 is pivotally connected to the lower-section can body 102 and may engage the lower-section can body by magnetic force. In particular, a first magnet 188 is press fitted or otherwise securely received into a lower pocket 190 at the side edge of the door body 107. A second magnet 196 is secured to a lower portion at the side edge of the lower-section can body 102 opposite the door body 117. A third magnet 198 is secured to an upper portion of the lower-section can body 102 at the side edge opposite the door body 107. A fourth magnet 192 is press fitted or otherwise securely received into an upper pocket 194 at the side edge of the door body 107. When the door body 107 closes, the first magnet 188 magnetically engages the second magnet 196 and the third magnet 198 magnetically engages the fourth magnet 192.

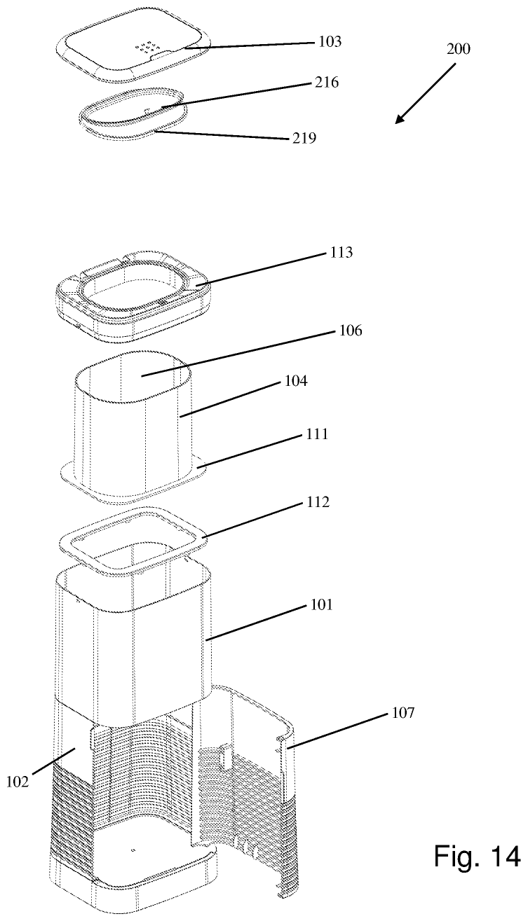

FIGS. 14 to 16 show another embodiment of the present invention. This embodiment is similar to that shown in FIGS. 8 to 13, except as discussed below. In this embodiment elements that are similar in function with the embodiment of FIGS. 8-13 will be given the same reference numbers. In this embodiment, inner cover 216 of trash can 200 is attached to the upper cover 103 such that the inner cover 216 opens and closes as the upper cover 103 opens and closes. In particular, as illustrated in FIG. 15, the inner cover 216 includes a first T-shaped tab 230 on the top side of the inner cover 216. The upper cover includes a second T-shaped tab 232 on the underside of the upper cover 103. A looped elastic band 234 such as a rubber band is looped around the first and second tabs 230, 232 to attach them to each other. The inner cover 216 is pivotally connected to outer frame 219, which is positioned upon the inner rim of the locating snap ring 113. Thus, as the upper cover 103 pivots upwardly on the rear end of the can and opens, the elastic band 234 tensions and causes the inner cover 216 to also pivot upwardly and open. In this opened position, the trash inlet is opened. Likewise, as the upper cover 103 pivots downwardly on the rear end of the can and closes, the elastic band 234 relaxes and the inner cover 216 also pivots downwardly and closes. In this closed position, the trash inlet is closed.

The invention is not limited by the embodiments described above which are presented as examples only but can be modified in various ways within the scope of protection defined by the appended patent claims.

Although various embodiments of the trash can have been shown and described, modifications may occur to those skilled in the art upon reading the specification. The present application includes such modifications and is limited only by the scope of the claims. Moreover, in the following claims, the terms “first,” “second,” and “third,” etc. are used merely as labels, and are not intended to impose numerical requirements on their objects or order of execution on their acts.

What is claimed is:

1. A trash can comprising a can body which comprises an upper-section can body and a lower-section can body, a trash bag being in use and arranged in the can body, wherein the can body comprises an upper part, a trash inlet formed in the upper part of the can body, an upper cover for sealing or opening the trash inlet, a support frame being arranged in the can body and comprising a through hole, and spare trash bags being continuously stacked and then sleeving the outer side of the support frame, wherein:
the trash bag in use and each of the spare trash bags is an elongate tubular trash bag,
the trash bag in use passes through the through hole in the support frame and is arranged at the inner side of the support frame,
the support frame keeps an opening part of the trash bag open,
when the trash bag in use is pulled, the elongate tubular trash bag is pulled out from the through hole in the support frame,
the support frame is located in the upper-section can body,
the lower-section can body is provided with a door body which can be opened in a rotating manner,
a cutter for cutting the trash bag is arranged at the inner side of the door body, wherein the trash can is provided with a base, and the lower-section can body is fixed on the base, and
one or more magnets provided on either the door body or the lower-section can body or both the door body and the lower-section can body, wherein the one or more magnets enable the door body to magnetically engage the lower-section can body when the door is closed.

2. The trash can of claim 1, further comprising a push-push mechanism, wherein the push-push mechanism is in operative connection with the upper-section can body, wherein the upper cover operatively engages the push-push mechanism such that the upper cover may be movable between an open position and a closed position by pushing the upper cover.

3. The trash can of claim 1, wherein an elastic cushion ring which is matched with the lower part of the support frame is arranged in the trash can.

4. The trash can of claim 1, wherein the upper-section can body is provided with a locating snap ring, wherein an inner cover is arranged in the locating snap ring, wherein the inner cover pivots relative to the trash can to open and close the trash inlet.

5. The trash can of claim 4, further comprising a locking knob, wherein the locking knob is in operative connection with the inner cover, wherein the locking knob is configure to lock the inner cover to prevent the cover from pivoting relative to the trash can to open and close the trash inlet.

6. A trash can comprising a can body which comprises an upper-section can body and a lower-section can body, a trash bag being in use and arranged in the can body, wherein the can body comprises an upper part, a trash inlet formed in the upper part of the can body, an upper cover for sealing or opening the trash inlet, a support frame being arranged in the can body and comprising a through hole, and spare trash bags being continuously stacked and then sleeving the outer side of the support frame, wherein:
the trash bag in use and each of the spare trash bags is an elongate tubular trash bag,
the trash bag in use passes through the through hole in the support frame and is arranged at the inner side of the support frame,
the support frame keeps an opening part of the trash bag open,
when the trash bag in use is pulled, the elongate tubular trash bag is pulled out from the through hole in the support frame,
the support frame is located in the upper-section can body,
the lower-section can body is provided with a door body which can be opened in a rotating manner, and
a cutter for cutting the trash bag is arranged at the inner side of the door body, wherein the upper-section can body is provided with a locating snap ring, wherein an inner cover is arranged in the locating snap ring, wherein the inner cover pivots relative to the trash can from an open position that opens the trash inlet to a closed position that closes the trash inlet.

7. The trash can according to the claim 6, further comprising a locking knob, wherein the locking knob is in operative connection with the inner cover, wherein the locking knob is configure to lock the inner cover to prevent the cover from pivoting relative to the trash can between the open and closed position.

8. The trash can of claim 6, further comprising an inner cover spring, wherein the inner cover spring biases the inner cover upwardly in the closed position to seal the trash inlet, wherein the inner cover is pivotable downwardly away from the locating snap ring in the open position to open the trash inlet.

9. The trash can according to the claim 8, further comprising a locking knob, wherein the locking knob is in operative connection with the inner cover, wherein the locking knob includes an arm, wherein the locking knob is configure to be in a locked position to lock the inner cover to prevent the cover from pivoting relative to the trash can to open and close the trash inlet, wherein the arm engages an underside of the inner cover in the locked position.

10. The trash can of claim 6, further comprising a freshener housing, wherein the freshener housing is removably connected to the inner cover.

11. The trash can of claim 10, wherein the inner cover comprises first and second rails located on an underside of the inner cover, wherein the first and second rails slidably receive the freshener housing.

12. The trash can of claim 6, wherein the inner cover is in operative connection with the upper cover such that the inner cover pivots with the upper cover, wherein the upper cover and inner cover are pivotable upwardly from the closed position in which the trash inlet is closed to the open position to open the trash inlet.

13. The trash can of claim 12, wherein the inner cover is attached to the upper cover by an elastic band.

14. The trash can of claim 6, further comprising a push-push mechanism, wherein the push-push mechanism is in operative connection with the upper-section can body, wherein the upper cover operatively engages the push-push mechanism such that the upper cover may be movable between an open position and a closed position by pushing the upper cover.

15. The trash can of claim 6, wherein an elastic cushion ring which is matched with the lower part of the support frame is arranged in the trash can.

16. The trash can of claim 6, wherein an elastic cushion ring which is matched with the lower part of the support frame is arranged in the trash can.

17. A trash can comprising a can body which comprises an upper-section can body and a lower-section can body, a trash bag being in use and arranged in the can body, wherein the can body comprises an upper part, a trash inlet formed in the upper part of the can body, an upper cover for sealing or opening the trash inlet, a support frame being arranged in the can body and comprising a through hole, and spare trash bags being continuously stacked and then sleeving the outer side of the support frame, wherein:
the trash bag in use and each of the spare trash bags is an elongate tubular trash bag,
the trash bag in use passes through the through hole in the support frame and is arranged at the inner side of the support frame,
the support frame keeps an opening part of the trash bag open,
when the trash bag in use is pulled, the elongate tubular trash bag is pulled out from the through hole in the support frame,
the support frame is located in the upper-section can body,
the lower-section can body is provided with a door body which can be opened in a rotating manner,
a cutter for cutting the trash bag is arranged at the inner side of the door body, and
a push-push mechanism, wherein the push-push mechanism is in operative connection with the upper-section can body, wherein the upper cover operatively engages the push-push mechanism such that the upper cover may be movable between an open position and a closed position by pushing the upper cover.

18. The trash can of claim 17, wherein the upper cover includes a tang, wherein the tang is removably connected to the push-push mechanism.

19. The trash can of claim 17, wherein the upper-section can body is provided with a locating snap ring, wherein the push-push-mechanism is provided in an opening of the locating snap ring.

20. The trash can of claim 17, wherein an elastic cushion ring which is matched with the lower part of the support frame is arranged in the trash can.
